(19) United States
(12) Patent Application Publication
(10) Pub. No.: US 2020/0378801 A1
(43) Pub. Date: Dec. 3, 2020

(54) End Position Detection with the Aid of Two-Position Controller

(71) Applicant: ZF Friedrichshafen AG, Friedrichshafen (DE)

(72) Inventor: Martin Ruider, Schwarzhofen (DE)

(21) Appl. No.: 16/884,718

(22) Filed: May 27, 2020

(30) Foreign Application Priority Data
May 28, 2019 (DE) 10 2019 207 828.1

(51) Int. Cl. G01D 5/243; H01F 7/16; H01F 7/06

(52) U.S. Cl. CPC G01D 5/243; H01F 7/064; H01F 7/16

(57) ABSTRACT

A method for end position detection in an electromagnetic, bistable actuator (101) includes applying excitation energy to the actuator (101) with the aid of a two-position controller while an armature (103) of the actuator (101) is in an end position, and determining at least one value of a switching frequency of the two-position controller.

### CROSS-REFERENCE TO RELATED APPLICATION

The present application is related and has right of priority to German Patent Application No. 10 2019 207 828.1 filed on May 28, 2019, which is incorporated by reference in its entirety for all purposes.

### FIELD OF THE INVENTION

The invention relates generally to a method and to an arrangement for detecting end position.

### BACKGROUND

From the prior art, it is known to detect the position of the armature of an actuator in a sensorless manner. For example, publication DE 10 2005 018 012 A1 describes an electromagnetic actuator, the armature of which is displaceably mounted between two coils. In order to determine the position of the armature, an abruptly increasing voltage is applied to the two coils. The voltage progressions measured at the two coils are forwarded to a difference forming unit. The position of the armature can be determined on the basis of the output signal of the difference forming unit.

In the case of a bistable actuator, a position detection of the armature is frequently not necessary. Rather, it suffices to detect the end positions of the armature. The approaches known from the prior art are over-designed for this purpose.

### SUMMARY OF THE INVENTION

Example aspects of the invention detect the end positions in the case of an electromagnetic, bistable actuator, while avoiding the disadvantages inherent in the approach known from the prior art. In particular, the end position detection is to be simplified.

The method is utilized for end position detection in the case of an electromagnetic, bistable actuator.

An actuator is a mechanism for converting a signal into a mechanical variable. The mechanical variable acts on the condition of a technical system. The technical system can be, for example, a transmission. The actuators in the transmission are utilized, for example, for disengaging and/or engaging clutches. The actuator can also be integrated into the drive train of an all-wheel-driven vehicle, in order to decouple one of two driven axles of the vehicle from a torque flow proceeding from the drive of the vehicle to the axles, or to incorporate one of two driven axles of the vehicle into this torque flow as necessary.

An electromagnetic actuator converts an electrical signal into the mechanical variable. Electrical energy—excitation energy—is supplied to the actuator, which the actuator converts into the mechanical variable. The actuator includes an armature, which is moved via the conversion of the excitation energy and acts on the condition of the technical system.

End positions refer to end positions of the armature, between which the armature is displaceable. The armature is therefore displacable from a first end position into the second end position and from the second end position back into the first end position. It is not possible for the armature to move beyond the end positions.

In the case of a bistable actuator, the armature remains in the end positions o the actuator in a bistable manner, in particular without a supply of excitation energy. For this purpose, the armature includes a means for fixing the armature in the end positions. The armature is fixable in the end positions, for example, with the aid of a permanent magnet. The fixation of the actuator becomes effective as soon as the actuator has reached an end position. The fixation is releasable by supplying excitation energy.

According to example aspects of the invention, excitation energy is applied to the actuator with the aid of a two-position controller, while the actuator is located in an end position. The control parameter of the two-position controller is preferably an excitation current of the actuator. The excitation voltage is utilized as a manipulated variable in this case. Alternatively, the excitation voltage would be conceivable as a control parameter, while the excitation current serves as a manipulated variable. The two-position controller allows the excitation current, as a manipulated variable, to alternate between two switching thresholds. In the meantime, the excitation voltage periodically follows a rectangle function.

The switching thresholds of the two-position controller are rated in such a way that the mechanics of the actuator cannot follow the control dynamics. As a result, the armature remains in the end position, as desired, despite being acted upon by the two-position controller with excitation energy.

The inductance of the actuator changes depending on the position of the armature. This applies, in particular, for the case in which a permanent magnet is installed in the magnetic circuit of the actuator. Due to the changing inductance, the frequency at which the two-position controller applies excitation energy to the actuator changes as well. Example aspects of the invention makes use of this situation, in that at least one value of the switching frequency of the two-position controller is determined. Specifically, a value of the frequency of the voltage and/or of the current of the excitation energy can be determined. The determination takes place by measuring. This means, the switching frequency is either directly measured or at least one physical variable is measured, on the basis of which the switching frequency is calculated.

Due to the determination of the switching frequency according to example aspects of the invention, it is possible to determine the position of the armature of the actuator easily and without additional expenditure. If a permanent magnet is provided for implementing the bistability, no further measures are necessary for implementing the method according to example aspects of the invention, since the necessary change in inductance depending on the position of the armature already takes place due to the permanent magnet.

In one preferred example refinement, the determined value of the switching frequency is compared with reference values for the end positions of the armature. Specifically, a first value, which the switching frequency assumes when the actuator is in a first end position, and a second value, which the switching frequency assumes when the actuator is in a second end position, are predetermined. The first value of the switching frequency and the second value of the switching frequency are therefore determined before the remaining method steps are carried out. In particular, the determination preferably takes place not during the operation of the actuator, but rather before. The first value of the switching frequency and the second value of the switching frequency are preferably determined precisely once and can be utilized any number of times during the operation of the actuator in order to carry out the method according example aspects of to the refinement.

The method according to the example refinement provides that the predetermined values of the switching frequency are compared with the value of the switching frequency determined according to example aspects of the invention.

In one preferred example refinement, the first end position is output as the position of the armature, or is returned as the result, when the value of the switching frequency determined according to example aspects of the invention is identical to the first value. Correspondingly, the second end position is output as the position of the armature when the value of the switching frequency determined according to example aspects of the invention is identical to the second predetermined value.

An arrangement according to example aspects of the invention includes the above-described electromagnetic, bistable actuator and a control unit. A control unit is an embedded system in which functions are implemented for the open-loop or closed-loop control of at least one component outside the control unit. A control unit can include components that are not physically connected to one another. In particular, a control unit can have further control units.

According to example aspects of the invention, the arrangement includes the above-described two-position controller. The control unit is designed for determining the value of the switching frequency of the two-position controller.

Preferably, the control unit is refined in order to implement the above-described example refinements of the method according to example aspects of the invention.

### BRIEF DESCRIPTION OF THE DRAWINGS

A preferred exemplary embodiment of the invention is represented in FIG. 1. Identical reference numbers label identical or functionally identical features. Specifically:

FIG. 1 shows the time profile of excitation variables of an actuator.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

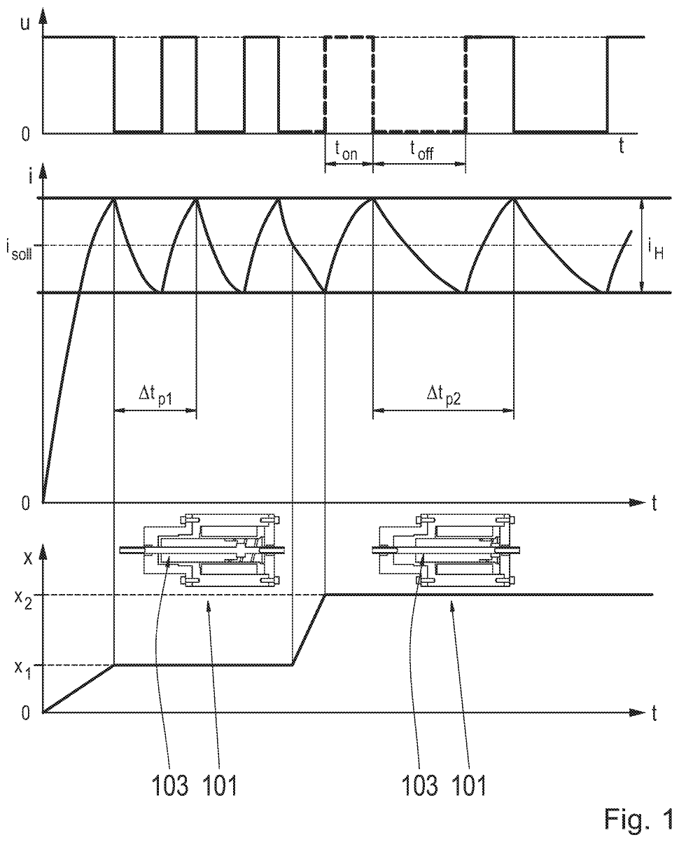

An actuator 101 represented in FIG. 1 includes an armature 103, which is axially displaceable via application of an excitation voltage. The axial position x of the armature 103 is plotted as a function of the time tin the lower diagram in FIG. 1. If the armature 103 is in a first end position represented on the left in FIG. 1, the axial position x of the armature 103 assumes an axial position x₁. The armature 103 assumes an axial position x₂ when the axial position x of the armature 103 is in a second end position represented on the right in FIG. 1.

In the upper diagram of FIG. 1, the progression of an excitation voltage u is plotted as a function of the time t. The excitation voltage u is generated by a two-position controller. Therefore, the excitation voltage u alternates between 0 and an upper limiting value, as a square wave signal.

The progression represented in the middle diagram results for the excitation current i as a function of the time t. A mean current iₛₒₗₗ is predefined as a reference variable for the two-position controller. The excitation current i then oscillates between an upper switching threshold and a lower switching threshold in a current band i_{H} around the mean current iₛₒₗₗ.

tₒₙ designates the switch-on time of the excitation voltage u and/or the time duration in which u assumes the upper limiting value in each case. Correspondingly, t_{off} designates the time period in which the excitation voltage u assumes the value 0 in each case.

The switching frequency f is

$$f = \frac{1}{{t}_{on} - {t}_{off}} .$$

The switching frequency f that sets in when the armature 103 assumes the first end position is greater than the switching frequency f that sets in when the armature 103 assumes the second end position. The reason therefor is the inductance, which has changed due to the different position of the armature 103. By evaluating the switching frequency f, it can therefore be determined whether the armature 103 assumes the first end position or the second end position. In particular, the evaluation of the frequency f makes it possible to differentiate between the two end positions.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE NUMBERS

101 actuator
103 armature

1-4: (canceled)

5. A method for end position detection in an electromagnetic, bistable actuator (101), comprising:
applying excitation energy to the actuator (101) with the aid of a two-position controller while an armature (103) of the actuator (101) is in an end position; and
determining at least one value of a switching frequency of the two-position controller.

6. The method of claim 5, further comprising comparing the determined value of the switching frequency with a first predetermined value and a second predetermined value,
wherein the switching frequency assumes the first predetermined value when the armature (103) is in a first end position, and the switching frequency assumes the second predetermined value when the armature (103) is in a second end position.

7. The method of claim 6, further comprising:
detecting a position of the armature (103) as the first end position when the determined value of the switching frequency corresponds to the first predetermined value; and
detecting the position of the armature (103) as the second end position when the determined value of the switching frequency corresponds to the second predetermined value.

8. An end position detection arrangement, comprising:
an electromagnetic, bistable actuator (101);
a control unit; and
a two-position controller configured for applying excitation energy to the actuator (101) when an armature (103) of the actuator (101) is in an end position,
wherein the control unit is configured for determining at least one value of a switching frequency of the two-position controller.
